(19) United States
(12) Patent Application Publication
(10) Pub. No.: US 2017/0243045 A1
(43) Pub. Date: Aug. 24, 2017

(54) FINGERPRINT IDENTIFICATION MODULE AND MANUFACTURING METHOD THEREOF

(71) Applicant: PRIMAX ELECTRONICS LTD., Taipei (TW)

(72) Inventors: Ching-Hui Chang, Taipei (TW); Tung-Ying Wu, Taipei (TW)

(21) Appl. No.: 15/411,165

(22) Filed: Jan. 20, 2017

Related U.S. Application Data
(60) Provisional application No. 62/297,360, filed on Feb. 19, 2016.

(51) Int. Cl. G06K 9/00

(52) U.S. Cl. CPC G06K 9/0002; G06K 9/00087; G06K 9/00053

(57) ABSTRACT

A fingerprint identification module includes a substrate, a fingerprint sensor die, a cover plate and a mold compound layer. The fingerprint sensor die is attached on the substrate for sensing a fingerprint image. The mold compound layer is formed over the substrate. The fingerprint sensor die and the cover plate over the substrate are molded together through the mold compound layer, and the cover plate is exposed. The fingerprint identification module has small thickness and enhanced sensing accuracy.

### FIELD OF THE INVENTION

The present invention relates to a biometric identification device, and more particularly to a fingerprint identification module.

### BACKGROUND OF THE INVENTION

A fingerprint identification device is used in an electronic product to read a fingerprint image. After the electronic product confirms that the read fingerprint image complies with a predetermined fingerprint file, the electronic product is unlocked. In the early stage, the fingerprint identification device is used in an access control system. Recently, with increasing development of the smart phone technologies, smart phones are usually equipped with fingerprint identification devices. In comparison with the fingerprint identification device of the access control system, the thickness of the fingerprint identification device is gradually reduced because the trend of designing the smart phone is toward slimness. Therefore, it is important to increase the accuracy of the fingerprint identification device to sense the fingerprint image.

FIG. 1 is a schematic view illustrating the structure of a conventional fingerprint identification module. As shown in FIG. 1, the conventional fingerprint identification module 10 comprises a fingerprint sensor die 11, a rigid circuit board 12, a flexible circuit board 13, a mold compound layer 14, a cover plate 16 and a reinforcement plate 17. The reinforcement plate 16 is used for increasing the flatness of the flexible circuit board 13. The fingerprint sensor die 11 is attached on the rigid circuit board 12 through an adhesive layer 12A. Moreover, the fingerprint sensor die 11 is connected with the rigid circuit board 12 through wires W. The rigid circuit board 12 and the flexible circuit board 13 are combined together through a conductive layer 13A. The flexible circuit board 13 and the reinforcement plate 17 are combined together through an adhesive layer 17A. The cover plate 16 is attached on the mold compound layer 14 through an adhesive layer 15.

For example, the fingerprint sensor die 11 is a capacitive fingerprint sensor die. When a user's finger is placed on the cover plate 16, the fingerprint sensor die 11 senses the fingerprint image and transmits the fingerprint image to an electronic device through the rigid circuit board 12 and the flexible circuit board 13. Consequently, the fingerprint image can be recognized by the electronic device. However, for those skilled in the art, the conventional fingerprint identification module 10 of FIG. 1 still has some drawbacks. Generally, in case that distance between a sensing surface of the fingerprint sensor die 11 and the finger is smaller, the accuracy of the fingerprint sensor die 11 (e.g., the capacitive fingerprint sensor die) for sensing the fingerprint is higher. For manufacturing the conventional fingerprint identification module 10, a molding process is firstly performed to form the mold compound layer 14 to encapsulate the fingerprint sensor die 11 and the wires W, then the adhesive layer 15 is coated on the top surface of the mold compound layer 14 to attach the cover plate 16, and finally the cover plate 16 is attached on the adhesive layer 15. As shown in FIG. 1, thickness of the cover plate 16 is equal to D1, the thickness of the adhesive layer 15 is equal to D2, and the thickness of the mold compound layer 14 overlying the fingerprint sensor die 11 is equal to D3. The distance between the finger and the sensing surface of the fingerprint sensor die 11 is equal to the overall thickness of D1, D2 and D3. This overall thickness increases the distance between a sensing surface of the fingerprint sensor die 11 and the finger.

The uneven thickness of the mold compound layer 14 is another drawback of the fingerprint identification module 10 of FIG. 1. Since it is difficult to precisely control the stress of the package structure during the process of forming the mold compound layer 14, the thickness of the mold compound layer 14 is not uniformly distributed. Consequently, the surface of the mold compound layer 14 is suffered from warpage. When the warpage of the mold compound layer 14 occurs, the thickness of the adhesive layer 15 overlying the mold compound layer 14 is also uneven. That is, the two lateral regions are thicker than the middle region, or the two lateral regions are thinner than the middle region. Due to the uneven thickness, the fiducial capacitance sensed by the fingerprint sensor die 11 is inconsistent. Under this circumstance, the possible of resulting in misjudgment is increased.

### SUMMARY OF THE INVENTION

The present invention provides a fingerprint identification module with small thickness and enhanced sensing accuracy and a manufacturing method of the fingerprint identification module.

In accordance with an aspect of the present invention, there is provided a fingerprint identification module. The fingerprint identification module includes a substrate, a fingerprint sensor die, a cover plate and a mold compound layer. The substrate includes plural electrical contacts. The fingerprint sensor die is attached on the substrate for sensing a fingerprint image. The fingerprint sensor die is connected with the plural electrical contacts of the substrate through plural wires, so that the fingerprint sensor die is electrically connected with the substrate. The mold compound layer is formed over the substrate. The fingerprint sensor die and the cover plate over the substrate are molded together through the mold compound layer, and the cover plate is exposed.

In accordance with another aspect of the present invention, there is provided a method for manufacturing a fingerprint identification module. In a step (a), plural fingerprint sensor chips are fixed on a substrate. Moreover, plural electrical contacts are formed on the substrate and arranged around each fingerprint sensor chip. In a step (b), the plural fingerprint sensor chips are connected with the substrate by a wire-bonding process, so that the plural fingerprint sensor chips are electrically connected with the substrate. In a step (c), a cover plate is placed over the plural fingerprint sensor chips. In a step (d), the plural fingerprint sensor chips and the cover plate are molded together through a mold compound layer, wherein the cover plate is exposed. In a step (e), a cutting process is performed to produce plural individual fingerprint sensor units. In a step (f), the plural individual fingerprint sensor units are fixed on a flexible circuit board. In a step (g), the flexible circuit board, and thus plural fingerprint identification modules are produced.

In accordance with a further aspect of the present invention, there is provided a method for manufacturing a fingerprint identification module. In a step (a), plural fingerprint sensor chips are fixed on a flexible circuit board. Moreover, plural electrical contacts are formed on the flexible circuit board and arranged around each fingerprint sensor chip. In a step (b), the plural fingerprint sensor chips are connected with the flexible circuit board by a wire-bonding process, so that the plural fingerprint sensor chips are electrically connected with the flexible circuit board. In a step (c), a cover plate is placed over the plural fingerprint sensor chips. In a step (d), the plural fingerprint sensor chips and the cover plate are molded together through a mold compound layer, wherein the cover plate is exposed. In a step (e), a cutting process is performed to produce plural individual plural fingerprint identification modules.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic view illustrating the structure of a conventional fingerprint identification module;

FIG. 2 is a schematic view illustrating the structure of a fingerprint identification module according to a first embodiment of the present invention;

FIG. 3 is a schematic view illustrating the structure of a fingerprint identification module according to a second embodiment of the present invention;

FIGS. 4A˜4E are schematic views illustrating the steps of a method for manufacturing a fingerprint identification module according to an embodiment of the present invention; and

FIGS. 5A˜5C are schematic views illustrating the steps of a method for manufacturing a fingerprint identification module according to another embodiment of the present invention.

### DETAILED DESCRIPTION OF THE PREFERRED EMBODIMENT

The present invention provides a fingerprint identification module and a manufacturing method of the fingerprint identification module.

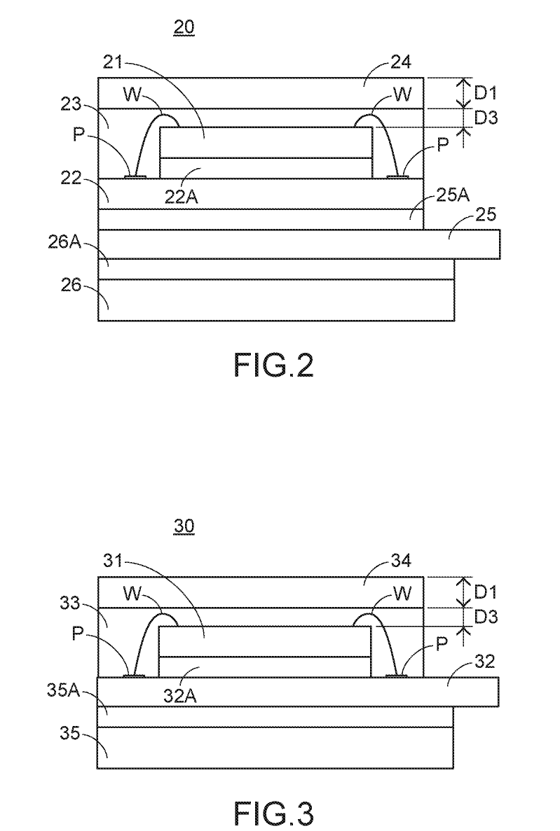

FIG. 2 is a schematic view illustrating the structure of a fingerprint identification module according to a first embodiment of the present invention. As shown in FIG. 2, the fingerprint identification module 20 comprises a fingerprint sensor die 21, a substrate 22, a mold compound layer 23, a cover plate 24 and a flexible circuit board 25. In the embodiment of FIG. 2, the fingerprint identification module 20 further comprises a metal plate 26. The fingerprint sensor die 21 is attached on the substrate 22 through an adhesive layer 22A. The cover plate 24 and the fingerprint sensor die 21 are molded together through the mold compound layer 23. The substrate 22 is attached on the flexible circuit board 25 through a conductive layer 25A. For example, the conductive layer 25A is a soldering layer. The substrate 22 and the flexible circuit board 25 are combined together and electrically connected with each other through the soldering layer by a surface mount technology (SMT). The metal plate 26 is attached on the flexible circuit board 25 through an adhesive layer 27A.

In this embodiment, the substrate 22 is a rigid circuit board. Moreover, plural electrical contacts P are formed on the substrate 22 and arranged around the fingerprint sensor die 21. The fingerprint sensor die 21 is connected with the electrical contacts P through wires W, and thus the fingerprint sensor die 21 and the substrate 22 are electrically connected with each other. As shown in FIG. 2, the cover plate 24 is formed on the mold compound layer 23, but the cover plate 24 is not contacted with the wires W.

An example of the fingerprint sensor die 21 of FIG. 2 includes but is not limited to a capacitive the fingerprint sensor die. After the fingerprint image is sensed by the fingerprint sensor die 21, the pixels of the fingerprint image are transferred to an external device (not shown) through the substrate 22 and the flexible circuit board 25. The fingerprint sensor die 21, the wires W, the plural electrical contacts P and the cover plate 24 are molded together through the mold compound layer 23. Due to the mold compound layer 23, the fingerprint identification module is isolated from the foreign dust. The cover plate 24 is used as a contact interface of between the user's finger and the fingerprint identification module. Moreover, even if the user's finger is frequently contacted with the surface of the fingerprint identification module, the cover plate 24 can protect the surface of the fingerprint identification module from damage. When the user's finger is placed on the cover plate 24, the fingerprint sensor die 21 can sense the fingerprint image of the finger. In an embodiment, the cover plate 24 is a glass plate or a ceramic plate. The metal plate 26 attached on the flexible circuit board 25 is used for increasing the flatness of the flexible circuit board 25. Moreover, the metal plate 26 can prevent formation of dry solder joints between the wires W and the plural electrical contacts P. In some embodiments, the metal plate 26 is omitted.

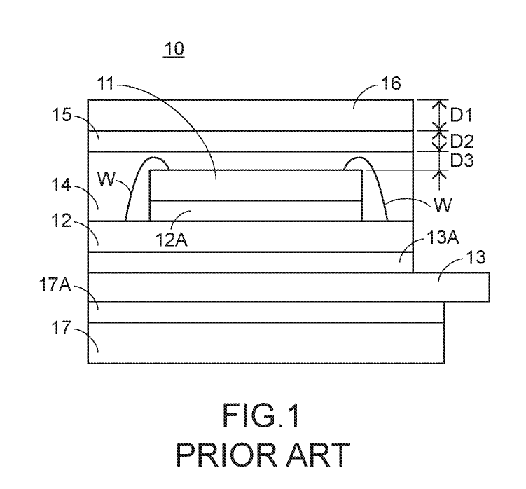

Please refer to the structure of the fingerprint identification module 20 as shown in FIG. 2. In the fingerprint identification module 20, the cover plate 24 and the fingerprint sensor die 21 are molded together through the mold compound layer 23. As previously described in FIG. 1, the thickness of the adhesive layer 15 is D2. Since the thickness of the adhesive layer is omitted, the distance between the top surface of the fingerprint sensor die 21 and the cover plate 24 is smaller than the distance between the top surface of the fingerprint sensor die and the cover plate of the fingerprint identification module 10 as shown in FIG. 1. Consequently, the sensing sensitivity of the fingerprint sensor die 21 is enhanced. Since the overall thickness of the fingerprint identification module 20 is reduced, the fingerprint identification module 20 has the slim appearance.

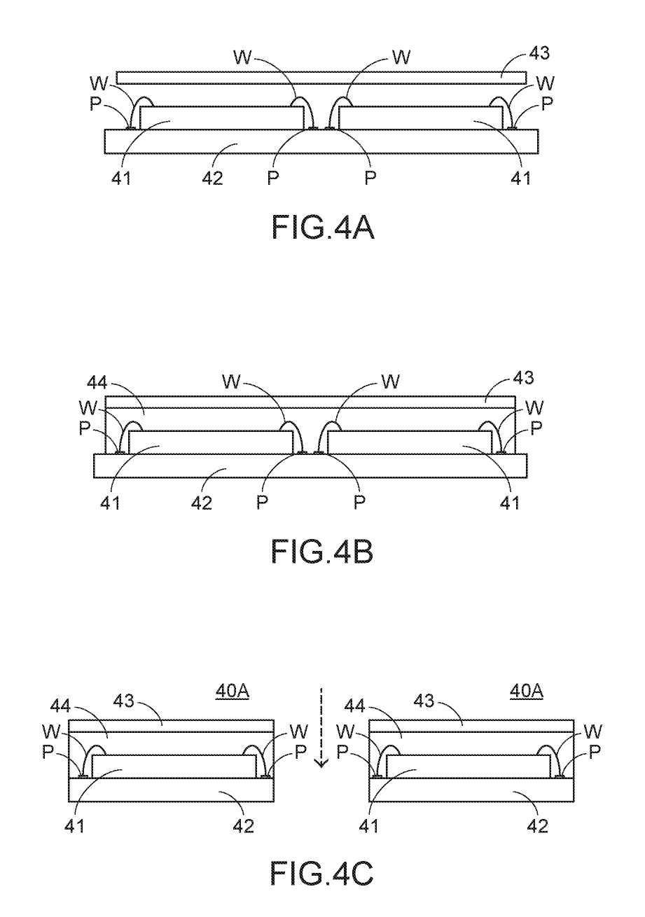

FIG. 3 is a schematic view illustrating the structure of a fingerprint identification module according to a second embodiment of the present invention. As shown in FIG. 3, the fingerprint identification module 30 comprises a fingerprint sensor die 31, a flexible circuit board 32, a mold compound layer 33, a cover plate 34 and a metal plate 35. Moreover, plural electrical contacts P are formed on the flexible circuit board 32 and arranged around the fingerprint sensor die 31. As shown in FIG. 3, the fingerprint sensor die 31 is connected with the electrical contacts P through wires W. The fingerprint sensor die 31 is attached on the flexible circuit board 32 through an adhesive layer 32A. The metal layer 35 is attached on a bottom surface of the flexible circuit board 32 through an adhesive layer 35A.

In the embodiment of FIG. 2, the electrical contacts P are formed on the substrate. Whereas, in the embodiment of FIG. 3, the electrical contacts P are directly formed on the flexible circuit board 32. Since the fingerprint identification module of the embodiment of FIG. 3 is not equipped with the rigid circuit board, the thickness of the fingerprint identification module is further reduced.

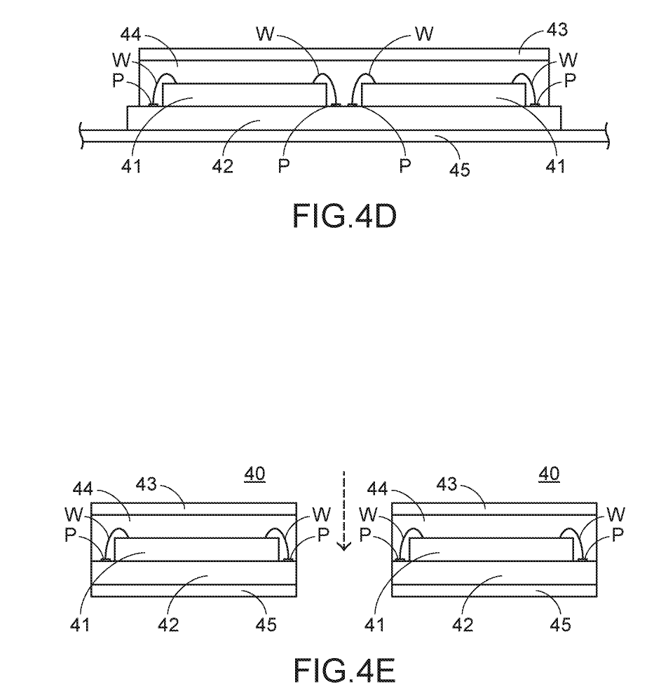

FIGS. 4A˜4E are schematic views illustrating the steps of a method for manufacturing a fingerprint identification module according to an embodiment of the present invention. For succinctness, the adhesive layers and the conductive layer are not shown in the drawings. Firstly, as shown in FIG. 4A, plural fingerprint sensor dies 41 are attached on the same substrate 42. For clarification, only two fingerprint sensor dies 41 are shown. In this embodiment, the substrate 42 is a rigid circuit board. Then, a wire-bonding process is performed on each fingerprint sensor die 41. Consequently, the fingerprint sensor dies 41 are electrically connected with the electrical contacts P of the substrate 42 through wires W. After the wire-bonding process, the cover plate 43 is positioned in a molding tool (not shown) and disposed over the fingerprint sensor dies 41. Then, a molding process is performed to form a mold compound layer 44. Consequently, the fingerprint sensor dies 41 and the cover plate 43 are molded together through the mold compound layer 44, and the top surface of the cover plate 43 is exposed (see FIG. 4B). Then, as shown in FIG. 4C, the plural fingerprint sensor dies 41 on the same substrate 42 are cut into plural individual fingerprint sensor units 40A. Then, as shown in FIG. 4D, the plural individual fingerprint sensor units 40A are attached on the same flexible circuit board 46 by a surface mount technology (SMT). Then, by cutting the flexible circuit board 45, plural individual fingerprint identification modules 40 are produced (see FIG. 4E).

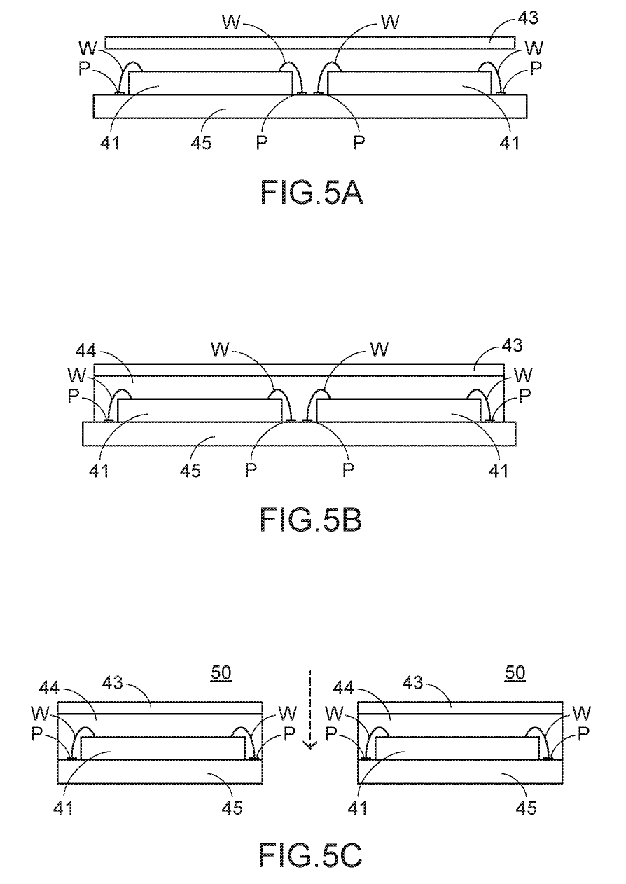

FIGS. 5A˜5C are schematic views illustrating the steps of a method for manufacturing a fingerprint identification module according to another embodiment of the present invention. In this embodiment, the rigid circuit board 42 is omitted. That is, the flexible circuit board 45 is directly used as the substrate. Firstly, as shown in FIG. 5A, plural fingerprint sensor dies 41 are attached on the same flexible circuit board 45. For clarification, only two fingerprint sensor dies 41 are shown. Then, a wire-bonding process is performed on each fingerprint sensor die 41. Consequently, the fingerprint sensor dies 41 are electrically connected with the electrical contacts P of the flexible circuit board 46 through wires W. After the wire-bonding process is performed, the cover plate 43 is positioned over the plural fingerprint sensor dies 41. Then, a molding process is performed to form a mold compound layer 44. Consequently, the fingerprint sensor dies 41 and the cover plate 43 are molded together through the mold compound layer 44, and the top surface of the cover plate 43 is exposed (see FIG. 5B). Then, as shown in FIG. 5C, the plural fingerprint sensor dies 41 on the same flexible circuit board 45 are cut into plural individual fingerprint identification modules 50.

In accordance with the manufacturing method of the present invention, the cover plate 43 is fixed in the fingerprint identification module the mold compound layer. In case that the mold compound layer 44 is suffered from warpage, the cover plate 43 has the similar warpage and deformation. Under this circumstance, the distance between the sensing surface of the fingerprint sensor die 41 and the cover plate 43 is kept unchanged. Consequently, the misjudgment problem resulted from warpage and deformation is overcome.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A fingerprint identification module, comprising:
a substrate comprising plural electrical contacts;
a fingerprint sensor die attached on the substrate and sensing a fingerprint image, wherein the fingerprint sensor die is connected with the plural electrical contacts of the substrate through plural wires, so that the fingerprint sensor die is electrically connected with the substrate;
a cover plate; and
a mold compound layer formed over the substrate, wherein the fingerprint sensor die and the cover plate over the substrate are molded together through the mold compound layer, and the cover plate is exposed.

2. The fingerprint identification module according to claim 1, wherein the cover plate is not contacted with the plural wires.

3. The fingerprint identification module according to claim 1, wherein the substrate is a flexible circuit board.

4. The fingerprint identification module according to claim 1, wherein the substrate is a rigid circuit board, the fingerprint identification module further comprises a flexible circuit board, and the flexible circuit board is attached on the substrate.

5. The fingerprint identification module according to claim 1, wherein the cover plate is a ceramic plate or a glass plate.

6. A method for manufacturing a fingerprint identification module, the method comprising steps of:
(a) fixing plural fingerprint sensor chips on a substrate, wherein plural electrical contacts are formed on the substrate and arranged around each fingerprint sensor chip;
(b) connecting the plural fingerprint sensor chips with the substrate by a wire-bonding process, so that the plural fingerprint sensor chips are electrically connected with the substrate;
(c) placing a cover plate over the plural fingerprint sensor chips;
(d) allowing the plural fingerprint sensor chips and the cover plate to be molded together through a mold compound layer, wherein the cover plate is exposed;
(e) performing a cutting process to produce plural individual fingerprint sensor units;
(f) fixing the plural individual fingerprint sensor units on a flexible circuit board; and
(g) cutting the flexible circuit board, thereby producing plural fingerprint identification modules.

7. The method according to claim 6, wherein the cover plate is not contacted with the plural wires.

8. The method according to claim 6, wherein the substrate is a rigid circuit board.

9. A method for manufacturing a fingerprint identification module, the method comprising steps of:
(a) fixing plural fingerprint sensor chips on a flexible circuit board, wherein plural electrical contacts are formed on the flexible circuit board and arranged around each fingerprint sensor chip;
(b) connecting the plural fingerprint sensor chips with the flexible circuit board by a wire-bonding process, so that the plural fingerprint sensor chips are electrically connected with the flexible circuit board;
(c) placing a cover plate over the plural fingerprint sensor chips;
(d) allowing the plural fingerprint sensor chips and the cover plate to be molded together through a mold compound layer, wherein the cover plate is exposed; and
(e) performing a cutting process to produce plural individual plural fingerprint identification modules.

10. The method according to claim 9, wherein the cover plate is not contacted with the plural wires.
